(19) United States
(12) Patent Application Publication
(10) Pub. No.: US 2024/0214112 A1
(43) Pub. Date: Jun. 27, 2024

(54) METHOD FOR RETRANSMISSION OF BROADCAST SIGNAL USING MULTI-ANTENNA SIGNAL BASED ON CHANNEL BONDING AND APPARATUS FOR THE SAME

(71) Applicant: ELECTRONICS AND TELECOMMUNICATIONS RESEARCH INSTITUTE, Daejeon (KR)

(72) Inventors: Jae-Hyun SEO, Daejeon (KR); Hoi-Yoon JUNG, Sejong-si (KR); Sung-Ik PARK, Daejeon (KR); Bo-Mi LIM, Daejeon (KR); Dong-Joon CHOI, Daejeon (KR); Nam-Ho HUR, Sejong-si (KR)

(21) Appl. No.: 18/540,654

(22) Filed: Dec. 14, 2023

(30) Foreign Application Priority Data
Dec. 23, 2022 (KR) 10-2022-0183397

(51) Int. Cl. H04L 1/00; H04L 5/00

(52) U.S. Cl. CPC H04L 1/0041; H04L 1/0071; H04L 5/0053; H04L 2001/0093

(57) ABSTRACT

Disclosed herein are a method for processing a retransmission broadcast signal using multi-antenna signals based on channel bonding and an apparatus for the same. The apparatus includes a stream multiplexing (muxing) unit for generating a single piece of input data from signals received from two or more reception channels, an input formatting unit for converting the input data into a Physical Layer Pipe (PLP), a stream partitioning unit for segmenting the physical layer pipe into pieces of data to be respectively transmitted over two or more transmission channels, and two or more retransmission-signal-processing units for retransmitting the pieces of data to the respective transmission channels corresponding thereto through multiple transmission antennas.

### CROSS REFERENCE TO RELATED APPLICATION

This application claims the benefit of Korean Patent Application No. 10-2022-0183397, filed Dec. 23, 2022, which is hereby incorporated by reference in its entirety into this application.

### BACKGROUND OF THE INVENTION

### 1. Technical Field

The present disclosure relates generally to technology for retransmitting broadcast signals using multi-antenna signals based on channel bonding, and more particularly to a structure of a signal retransmission apparatus that supports both channel bonding and multi-antenna transmission technology and a method using the apparatus in order to retransmit broadcast signals received from multiple channels or received through a combination of channel bonding and multi-antenna signals.

### 2. Description of the Related Art

Conventional retransmission-broadcast-signal-processing apparatuses generate transmission signals to be retransmitted through a single Radio Frequency (RF) channel by performing remodulation using the same transmission parameters as those for the transmission signals based on the single RF channel. In order to retransmit broadcast signals received from two or more RF channels, a number of retransmission-signal-processing apparatuses equal to the number of RF channels is required. When channel bonding technology or multi-antenna transmission technology is used, about twice the transfer rate of conventional broadcast signals can be achieved, whereby it becomes possible to efficiently retransmit high-capacity broadcast data using such transmission technology.

In order to retransmit high-capacity broadcast data using multiple channels or using channel bonding technology and multi-antenna technology, a retransmission-signal-processing apparatus that supports both channel bonding technology and multi-antenna technology is required.

### DOCUMENTS OF RELATED ART

(Patent Document 1) Korean Patent Application Publication No. 10-2018-0132525, published on Dec. 12, 2018 and titled “Method of transmitting/receiving broadcast signal using combination of multiple antenna schemes and layered division multiplexing and apparatus for the same”.

### SUMMARY OF THE INVENTION

An object of the present disclosure is to provide a structure of a retransmission-signal-processing apparatus that supports both channel bonding technology and multi-antenna technology in order to efficiently retransmit broadcast data received from multiple channels, broadcast data received using a channel bonding transmission technology, broadcast data received using a multi-antenna transmission technology, or high-capacity broadcast data received using a combination of these transmission technologies.

Another object of the present disclosure is to provide a structure of a retransmission-signal-processing apparatus that can be applied to any of the case in which the broadcast data to be retransmitted is formed based on four RF channels, the case in which the broadcast data to be retransmitted is formed based on two RF channels and two antennas, the case in which the broadcast data to be retransmitted is formed based on two channel combinations using four RF channels, and the case in which the broadcast data to be retransmitted is formed based on combinations of these configurations.

In order to accomplish the above objects, an apparatus for processing a retransmission broadcast signal according to the present disclosure includes a stream multiplexing (muxing) unit for generating a single piece of input data from signals received from two or more reception channels, an input formatting unit for converting the input data into a Physical Layer Pipe (PLP), a stream partitioning unit for segmenting the physical layer pipe into pieces of data to be respectively transmitted over two or more transmission channels, and two or more retransmission-signal-processing units for retransmitting the pieces of data to the respective transmission channels corresponding thereto through multiple transmission antennas.

Here, the retransmission-signal-processing unit may include a Bit-Interleaved Coded Modulation (BICM) unit for segmenting the pieces of data into data cells to be respectively transmitted through the multiple transmission antennas and outputting the data cells, a Multiple-Input Multiple-Output (MIMO) precoding unit for performing stream combining, IQ polarization interleaving, and phase hopping on each of the data cells and outputting the data cell, and framing and interleaving units and waveform generation units corresponding to the multiple transmission antennas.

Here, the retransmission-signal-processing unit may further include a cell exchange unit for performing data exchange for changing the transmission channel for a data cell, the index of which is an odd number.

Here, the apparatus may further include a signaling information unit for extracting information about transmission parameters from the received signals and a retransmission parameter unit for calculating the total amount of data based on the transmission parameters and acquiring transmission parameters to be applied to the retransmission-signal-processing unit.

Here, the stream partitioning unit may distribute data depending on the amount of data to be transmitted through each of the two or more transmission channels.

Here, the BICM unit may include a Forward Error Correction (FEC) unit for generating an FEC frame using a baseband packet, a Bit Interleaver (BIL) unit for performing bit interleaving on the FEC frame, and a Multiple-Input Multiple-Output (MIMO) mapping unit for segmentation into the data cells to be respectively transmitted through the multiple transmission antennas.

Here, the MIMO mapping unit may include a demultiplexer for segmenting a bitstream into data cells and a bit-to-IQ mapping unit for performing constellation mapping on the data cells generated by the demultiplexer.

Here, the bit-to-IQ mapping unit may map a data cell to antenna 1 when the index of the data cell is an even number, and may map the data cell to antenna 2 when the index of the data cell is an odd number.

Here, the MIMO precoding unit may include a stream combining unit, an IQ polarization interleaving unit, and a phase hopping unit, and the stream combining unit, the IQ polarization interleaving unit, and the phase hopping unit may be individually enabled or disabled.

Here, the retransmission-signal-processing unit may further include a cell-to-bit converter unit for converting the data cells back into bits by performing an inverse operation of the constellation mapping.

Also, an apparatus for processing a retransmission broadcast signal according to another embodiment of the present disclosure includes a stream muxing unit for generating a single piece of input data from signals received from two or more channels through two or more reception antennas, an input formatting unit for converting the input data into a Physical Layer Pipe (PLP), a stream partitioning unit for segmenting the physical layer pipe into pieces of data to be respectively transmitted over two or more transmission channels, and two or more retransmission-signal-processing units for retransmitting the pieces of data to the respective transmission channels corresponding thereto through multiple transmission antennas.

Also, a method for processing a retransmission broadcast signal according to an embodiment of the present disclosure includes generating, by a stream muxing unit of an apparatus for processing a retransmission broadcast signal using multi-antenna signals based on channel bonding, a single piece of input data from signals received from two or more reception channels; converting, by an input formatting unit of the apparatus, the input data into a Physical Layer Pipe (PLP); segmenting, by a stream partitioning unit of the apparatus, the physical layer pipe into pieces of data to be respectively transmitted over two or more transmission channels; and retransmitting, by two or more retransmission-signal-processing units of the apparatus, the pieces of data to the respective transmission channels corresponding thereto through multiple transmission antennas.

Also, a method for processing a retransmission broadcast signal according to another embodiment of the present disclosure includes generating, by a stream muxing unit of an apparatus for processing a retransmission broadcast signal using multi-antenna signals based on channel bonding, a single piece of input data from signals received from two or more channels through two or more reception antennas; converting, by an input formatting unit of the apparatus, the input data into a Physical Layer Pipe (PLP); segmenting, by a stream partitioning unit of the apparatus, the physical layer pipe into pieces of data to be respectively transmitted to two or more transmission channels; and retransmitting, by two or more retransmission-signal-processing units of the apparatus, the pieces of data to the respective transmission channels corresponding thereto through multiple transmission antennas.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating an example of a transmitter and a receiver using a single channel and a single antenna in a broadcast system;

FIG. 2 is a block diagram illustrating an example of a transmitter and a receiver that support multi-antenna transmission technology in a broadcast system;

FIG. 3 is a block diagram illustrating an example of a transmitter and a receiver that support channel bonding technology in a broadcast system;

FIG. 4 is a flowchart illustrating a method for processing a retransmission broadcast signal using multi-antenna signals based on channel bonding according to an embodiment of the present disclosure;

FIG. 5 is a view illustrating a first embodiment of a retransmission-broadcast-signal-processing apparatus that supports both channel bonding transmission technology and multi-antenna transmission technology according to the present disclosure;

FIG. 6 is a view illustrating a second embodiment of the retransmission-broadcast-signal-processing apparatus that supports both channel bonding transmission technology and multi-antenna transmission technology according to the present disclosure;

FIG. 7 is a view illustrating a third embodiment of the retransmission-broadcast-signal-processing apparatus that supports both channel bonding transmission technology and multi-antenna transmission technology according to the present disclosure;

FIG. 8 is a view illustrating a fourth embodiment of the retransmission-broadcast-signal-processing apparatus that supports both channel bonding transmission technology and multi-antenna transmission technology according to the present disclosure;

FIG. 9 is a flowchart illustrating a method for processing a retransmission broadcast signal using multi-antenna signals based on channel bonding according to another embodiment of the present disclosure;

FIG. 10 is a view illustrating a second embodiment of a receiver in a retransmission-broadcast-signal-processing apparatus that supports both channel bonding transmission technology and multi-antenna transmission technology according to the present disclosure;

FIG. 11 is a view illustrating a third embodiment of the receiver in the retransmission-broadcast-signal-processing apparatus that supports both channel bonding transmission technology and multi-antenna transmission technology according to the present disclosure;

FIG. 12 is a view illustrating a fourth embodiment of the receiver in the retransmission-broadcast-signal-processing apparatus that supports both channel bonding transmission technology and multi-antenna transmission technology according to the present disclosure;

FIG. 13 is a view illustrating a fifth embodiment of the receiver in the retransmission-broadcast-signal-processing apparatus that supports both channel bonding transmission technology and multi-antenna transmission technology according to the present disclosure;

FIG. 14 is a view illustrating a sixth embodiment of the receiver in the retransmission-broadcast-signal-processing apparatus that supports both channel bonding transmission technology and multi-antenna transmission technology according to the present disclosure; and

FIG. 15 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Hereinafter, a preferred embodiment of the present disclosure will be described in detail with reference to the accompanying drawings.

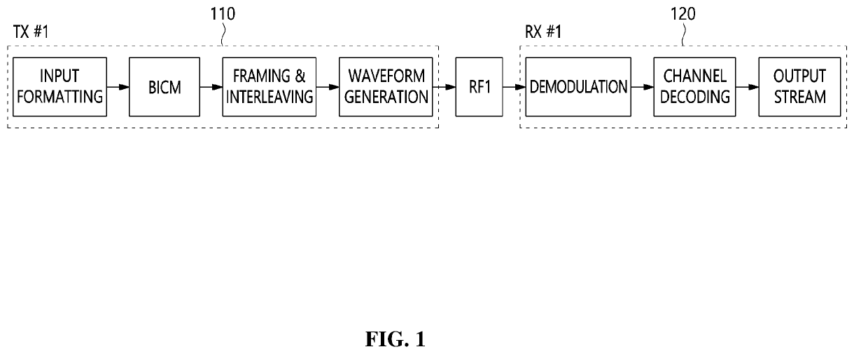

FIG. 1 is a block diagram illustrating an example of a transmitter and a receiver that use a single channel and a single antenna in a broadcast system.

Referring to FIG. 1, the transmitter TX #1 110 includes an input formatting block, a Bit-Interleaved Coded Modulation (BICM) block, a framing and interleaving block (framing & interleaving), and a waveform generation block, and the receiver RX #1 120 includes a demodulation block, a channel decoding block, and an output stream block.

First, input data may be converted into a Physical Layer Pipe (PLP) through the input formatting block of the transmitter 110. The PLP is input to the BICM block.

The BICM block may include three subblocks, which are a Forward Error Correction (FEC) block, a Bit Interleaver (BIL) block, and a Mapper (MAP) block. The FEC block generates an FEC frame using a baseband packet. Subsequently, the BIL block performs bit interleaving on the FEC frame generated by the FEC block, and the MAP block performs constellation mapping.

The frame processed as described above passes through the framing and interleaving block and the waveform generation block of the transmitter 110.

Here, the output of framing in the framing and interleaving block may include components such as a preamble and a subframe, and interleaving may include interleaving in time and frequency domains.

Here, the waveform generation block performs insertion of a pilot, a Multiple-Input Single-Output (MISO) function, Inverse Fast Fourier Transform (IFFT), insertion of a guard interval, and insertion of a bootstrap.

The signal passing through the waveform generation block of the transmitter 110 is transmitted to the receiver 120 through a single antenna RF1.

The demodulation block of the receiver 120 demodulates the received signal.

Subsequently, the channel decoding block performs channel decoding, and the output stream block outputs data.

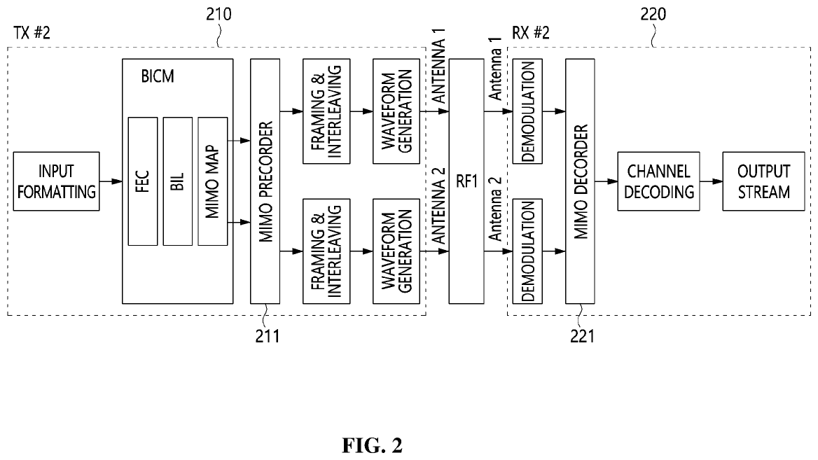

FIG. 2 is a block diagram illustrating an example of a transmitter and a receiver that support multi-antenna transmission technology in a broadcast system.

Referring to FIG. 2, the transmitter TX #2 210 may include an input formatting block, a BICM block, framing and interleaving blocks, and waveform generation blocks, and the receiver RX #2 220 may include demodulation blocks, a Multiple-Input Multiple-Output (MIMO) decoder block, a channel decoding block, and an output stream block.

First, input data is converted into a Physical Layer Pipe (PLP) through the input formatting block of the transmitter 210. The PLP is input to the BICM block.

The BICM block may include three subblocks, which are a Forward Error Correction (FEC) block, a Bit Interleaver (BIL) block, and a MIMO Mapper (MIMO MAP) block. The FEC block generates an FEC frame using a baseband packet, and the BIL block performs bit interleaving on the FEC frame generated by the FEC block. The MIMO MAP block includes a demultiplexer block and a bit-to-IQ mapping block. The demultiplexer block serves to segment a bitstream into data cells. Here, the number of data cells that are output may vary depending on a modulation order. The bit-to-IQ mapping block performs constellation mapping on the data cells generated by the demultiplexer block. Here, when the index of the data cell is an even number, the data cell is mapped to transmission antenna 1 (Antenna 1), whereas when the index of the data cell is an odd number, the data cell is mapped to transmission antenna 2 (Antenna 2). The output divided into the data cells for transmission antenna 1 and the data cells for transmission antenna 2 is input to a MIMO precoder block 211.

The MIMO precoder block 211 includes three subblocks, which are a stream combining block, an IQ polarization interleaving block, and a phase hopping block. Here, settings may be made such that the respective subblocks of the MIMO precoder block are individually enabled or disabled. The data for transmission antenna 1 and the data for transmission antenna 2, which are output from the MIMO precoder block 211, may be input to the respective framing and interleaving blocks and waveform generation blocks. That is, the framing and interleaving blocks may be present for transmission antenna 1 and transmission antenna 2 and the waveform generation blocks may be present for transmission antenna 1 and transmission antenna 2.

In the framing and interleaving block, the output of framing may include components such as a preamble and a subframe, and interleaving may include interleaving in time and frequency domains.

The waveform generation block may perform insertion of a pilot, a Multiple-Input Single-Output (MISO) function, Inverse Fast Fourier Transform (IFFT), insertion of a guard interval, insertion of a bootstrap, and the like. The signals passing through the waveform generation blocks may be transmitted to the receiver 220 through the respective antennas.

Subsequently, the demodulation blocks of the receiver 220 respectively demodulate the signals received through two reception antennas.

Subsequently, the MIMO decoder block 221 performs constellation de-mapping based on the signals that are input thereto after being demodulated by the two demodulation blocks.

The channel decoding block performs channel decoding, and the output stream block outputs data.

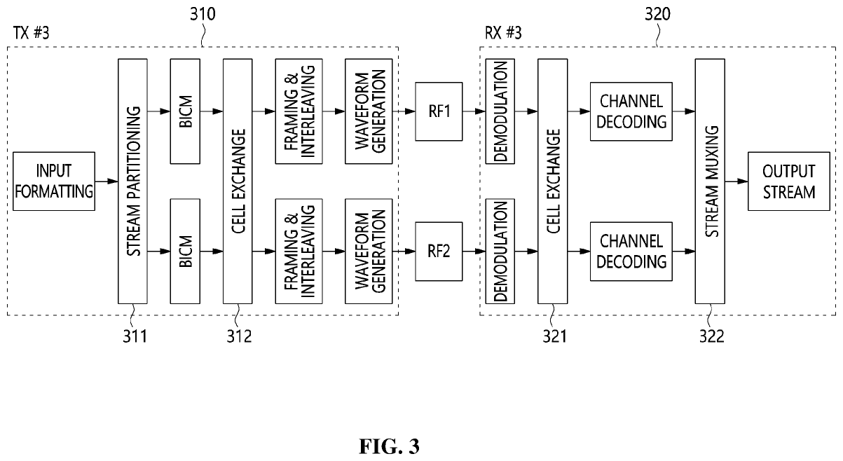

FIG. 3 is a block diagram illustrating an example of a transmitter and a receiver that support channel bonding technology in a broadcast system.

Referring to FIG. 3, the transmitter TX #3 310 includes an input formatting block, a stream partitioning block 311, BICM blocks, a cell exchange block 312, framing and interleaving blocks, and waveform generation blocks, and the receiver RX #3 320 includes demodulation blocks, a cell exchange block 321, channel decoding blocks, a stream multiplexing (muxing) block 322, and an output stream block.

First, data is converted into a Physical Layer Pipe (PLP) through the input formatting block of the transmitter 310. The PLP is input to the stream partitioning block 311.

The stream partitioning block 311 serves to segment the data to be transmitted to Radio Frequency (RF) channel 1 and RF channel 2. After data is segmented into transmission blocks for the respective RF channels, the transmission blocks are individually input to the BICM blocks.

Each of the BICM blocks includes three subblocks, which are a Forward Error Correction (FEC) block, a Bit Interleaver (BIL) block, and a mapper block. The FEC block generates an FEC frame using a baseband packet. The BIL block performs bit interleaving on the FEC frame generated by the FEC block. The mapper block includes a demultiplexer block and a bit-to-IQ mapping block. The demultiplexer block serves to segment a bitstream into data cells. Here, the number of data cells that are output may vary depending on a modulation order. The bit-to-IQ mapping block performs constellation mapping on the data cells generated by the demultiplexer block. The data passing through the BICM block is input to the cell exchange block 312.

The cell exchange block 312 may be enabled or disabled depending on a channel bonding mode. When the cell exchange block 312 is disabled, the input of the cell exchange block 312 may be the same as the output thereof.

When the cell exchange block 312 is enabled, the data of RF channel 1 and the data of RF channel 2 may be exchanged with each other depending on the index of the data cell. For example, when the index of the data cell is an even number, the data scheduled to be transmitted to RF channel 1 may be formed into a transmission signal and transmitted using the transmission path of RF channel 1 and the data scheduled to be transmitted to RF channel 2 may be formed into a transmission signal and transmitted using the transmission path of RF channel 2. That is, the input data of the cell exchange block may be the same as the output data thereof.

In another example, when the index of the data cell is an odd number, the data scheduled to be transmitted to RF channel 1 may be formed into a transmission signal and transmitted using the transmission path of RF channel 2 and the data scheduled to be transmitted to RF channel 2 may be formed into a transmission signal and transmitted using the transmission path of RF channel 1. That is, the RF channel number of the data input to the cell exchange block and the RF channel number of the data output from the cell exchange block may be exchanged. The data passing through the cell exchange block 312 is input to the framing and interleaving block and the waveform generation block for RF channel 1 or RF channel 2. That is, the framing and interleaving blocks may be present for RF channel 1 and RF channel 2, and the waveform generation blocks may be present for RF channel 1 and RF channel 2.

The output of framing in the framing and interleaving block may include components such as a preamble and a subframe, and interleaving may include interleaving in time and frequency domains.

The waveform generation block may perform insertion of a pilot, a Multiple-Input Single-Output (MISO) function, Inverse Fast Fourier Transform (IFFT), insertion of a guard interval, insertion of a bootstrap, and the like. The signals passing through the waveform generation blocks may be transmitted through the respective channels.

Subsequently, the demodulation blocks of the receiver 320 demodulate the respective signals received through RF channel 1 and RF channel 2.

The cell exchange block 321 of the receiver 320 performs the inverse process of the process performed depending on the channel bonding mode applied in the transmitter 310.

The channel decoding blocks respectively perform channel decoding for RF channel 1 and RF channel 2.

The channel-decoded data is converted into a single stream by the stream muxing block 322, and the output stream block outputs data.

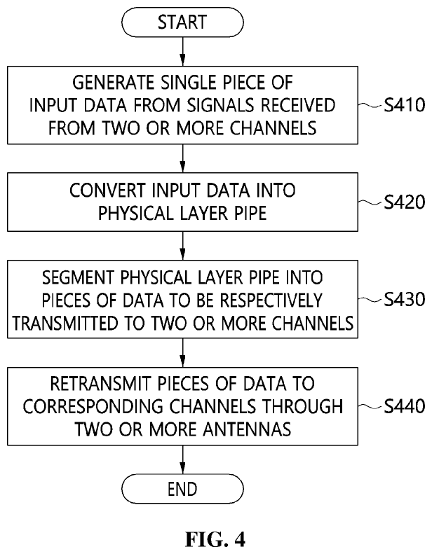

FIG. 4 is a flowchart illustrating a method for processing a retransmission broadcast signal using multi-antenna signals based on channel bonding according to an embodiment of the present disclosure.

Referring to FIG. 4, in the method for processing a retransmission broadcast signal using multi-antenna signals based on channel bonding according to an embodiment of the present disclosure, the stream muxing unit of an apparatus for processing a retransmission broadcast signal using multi-antenna signals based on channel bonding generates a single piece of input data from signals received from two or more reception channels at step S410.

Also, in the method for processing a retransmission broadcast signal using multi-antenna signals based on channel bonding according to an embodiment of the present disclosure, the input formatting unit of the apparatus for processing a retransmission broadcast signal using multi-antenna signals based on channel bonding converts the input data into a Physical Layer Pipe (PLP) at step S420.

Also, in the method for processing a retransmission broadcast signal using multi-antenna signals based on channel bonding according to an embodiment of the present disclosure, the stream partitioning unit of the apparatus for processing a retransmission broadcast signal using multi-antenna signals based on channel bonding segments the physical layer pipe into pieces of data to be respectively transmitted over two or more transmission channels at step S430.

Here, the pieces of data may be distributed depending on the amount of data to be transmitted through each of the two or more transmission channels.

Also, in the method for processing a retransmission broadcast signal using multi-antenna signals based on channel bonding according to an embodiment of the present disclosure, two or more retransmission-signal-processing units of the apparatus for processing a retransmission broadcast signal using multi-antenna signals based on channel bonding retransmit the pieces of data to the respective transmission channels corresponding thereto through multiple transmission antennas at step S440.

Here, the BICM unit of the retransmission-signal-processing unit may segment the pieces of data into the data cells to be respectively transmitted through the multiple transmission antennas, and may then output the data cells.

Here, the FEC unit of the BICM unit may generate an FEC frame using a baseband packet.

Here, the BIL unit of the BICM unit may perform bit interleaving on the FEC frame.

Here, the Multiple-Input Multiple-Output (MIMO) mapping unit of the BICM unit may perform segmentation into the data cells to be respectively transmitted through the multiple antennas.

Here, the demultiplexer of the MIMO mapping unit may segment a bitstream into the data cells.

Here, the bit-to-IQ mapping unit of the MIMO mapping unit may perform constellation mapping on the data cells generated by the demultiplexer.

Here, when the index of the data cell is an even number, the data cell may be mapped to antenna 1, whereas when the index of the data cell is an odd number, the data cell may be mapped to antenna 2.

Here, the Multiple-Input Multiple-Output (MIMO) precoding unit of the retransmission-signal-processing unit may perform stream combining, IQ polarization interleaving, and phase hopping on each of the data cells and output the data cell.

Here, the cell exchange unit of the retransmission-signal-processing unit may perform data exchange for changing the transmission channel for a data cell, the index of which is an odd number.

Here, the cell-to-bit converter unit of the retransmission-signal-processing unit performs inverse operation of constellation mapping, thereby converting the data cells back into bits.

Also, although not illustrated in FIG. 4, in the method for processing a retransmission broadcast signal using multi-antenna signals based on channel bonding according to an embodiment of the present disclosure, the signaling information unit of the apparatus for processing a retransmission broadcast signal using multi-antenna signals based on channel bonding extracts information about transmission parameters from the received signals.

Also, although not illustrated in FIG. 4, in the method for processing a retransmission broadcast signal using multi-antenna signals based on channel bonding according to an embodiment of the present disclosure, the retransmission parameter unit of the apparatus for processing a retransmission broadcast signal using multi-antenna signals based on channel bonding calculates the total amount of data based on the transmission parameters and acquires the transmission parameters to be applied to the retransmission-signal-processing unit.

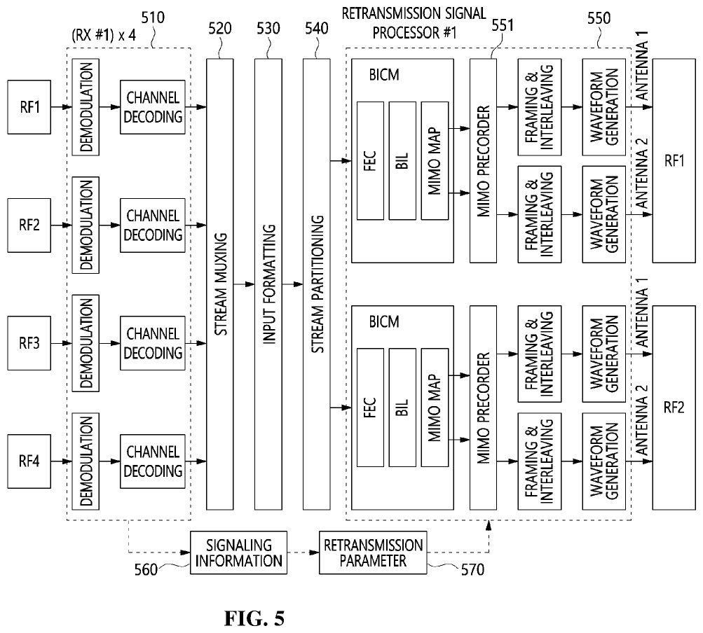

Hereinafter, a process of processing a retransmission broadcast signal based on various embodiments of a retransmission-broadcast-signal-processing apparatus that can be implemented according to the present disclosure will be described in detail with reference to FIGS. 5 to 8.

FIG. 5 is a view illustrating a first embodiment of a retransmission-broadcast-signal-processing apparatus that supports both channel bonding transmission technology and multi-antenna transmission technology according to the present disclosure.

Referring to FIG. 5, the retransmission-broadcast-signal-processing apparatus configured to receive signals from four RF channels RF1, RF2, RF3, and RF4 through a receiver 510, including four receiver modules RX #1, and to include a retransmission signal processor #1 550 supporting both channel bonding technology and multi-antenna transmission technology is illustrated.

The received signals are demodulated by the respective demodulation blocks of the four RF channels, the signals output from respective channel decoding blocks are converted into a single stream through a stream muxing block 520, and the input data converted into the single stream may be converted into a Physical Layer Pipe (PLP) through an input formatting block 530. The PLP is input to a stream partitioning block 540.

The stream partitioning block 540 serves to segment the data to be transmitted to RF channel 1 and RF channel 2. After data is segmented into transmission blocks for the respective RF channels, the transmission blocks are individually input to BICM blocks.

Here, a signaling information block 560 may extract information corresponding to transmission parameters (a Fast Fourier Transform (FFT) size, a guard interval length, a modulation order, a channel code rate, a pilot pattern, and the like) set by a broadcaster, and a retransmission parameter block 570 may calculate the total amount of data using the extracted transmission parameters, thereby acquiring the transmission parameters to be applied to a remodulation unit.

Each of the BICM blocks of the retransmission signal processor 550 includes three subblocks, which are a Forward Error Correction (FEC) block, a Bit Interleaver (BIL) block, and a MIMO mapper (MIMO MAP) block. The FEC block generates an FEC frame using a baseband packet. The BIL block performs bit interleaving on the FEC frame generated by the FEC block. The MIMO MAP block includes a demultiplexer block and a bit-to-IQ mapping block. The demultiplexer block serves to segment a bitstream into data cells. Here, the number of data cells that are output may vary depending on a modulation order. The bit-to-IQ mapping block performs constellation mapping on the data cells generated by the demultiplexer block.

Here, when the index of the data cell is an even number, the data cell may be mapped to transmission antenna 1, whereas when the index of the data cell is an odd number, the data cell may be mapped to transmission antenna 2. The output divided into the data cell for transmission antenna 1 and the data cell for transmission antenna 2 is input to a MIMO precoder block 551.

The MIMO precoder block 551 may include three subblocks, which are a stream combining block, an IQ polarization interleaving block, and a phase hopping block. Here, settings may be made such that the respective subblocks of the MIMO precoder block are individually enabled or disabled. The data for transmission antenna 1 and the data for transmission antenna 2 output from the MIMO precoder blocks may be input to respective framing and interleaving blocks and waveform generation blocks. That is, the framing and interleaving blocks may be present for transmission antenna 1 and transmission antenna 2, and the waveform generation blocks may be present for transmission antenna 1 and transmission antenna 2.

The output of framing in the framing and interleaving block may include components such as a preamble and a subframe, and interleaving may include interleaving in time and frequency domains.

The waveform generation block may perform insertion of a pilot, a Multiple-Input Single-Output (MISO) function, Inverse Fast Fourier Transform (IFFT), insertion of a guard interval, insertion of a bootstrap, and the like. The signal passing through the waveform generation block may be transmitted through the antenna.

Accordingly, the signals output from the four waveform generation blocks may be retransmitted by being distributed to transmission antenna 1 and transmission antenna 2 corresponding to RF channel 1 and transmission antenna 1 and transmission antenna 2 corresponding to RF channel 2.

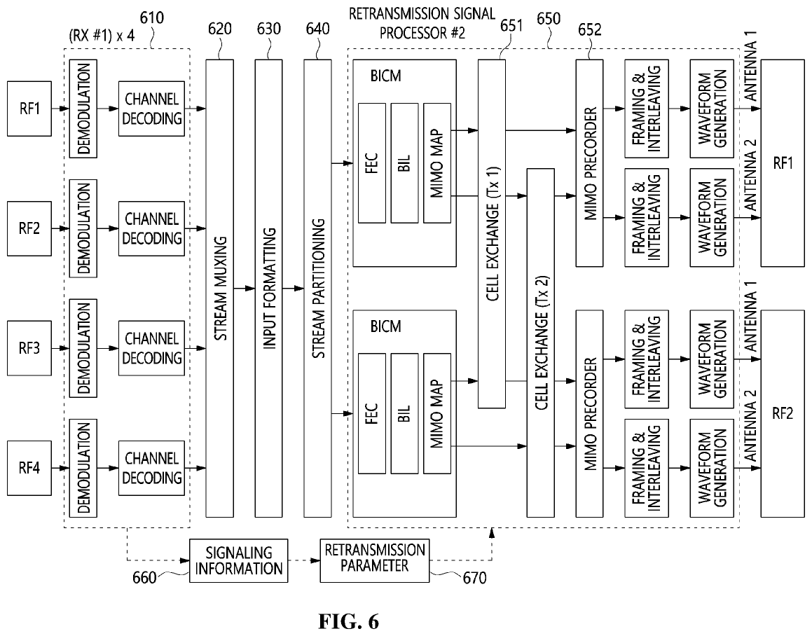

FIG. 6 is a view illustrating a second embodiment of a retransmission-broadcast-signal-processing apparatus that supports both channel bonding transmission technology and multi-antenna transmission technology according to the present disclosure.

Referring to FIG. 6, the retransmission-broadcast-signal-processing apparatus configured to receive signals from four RF channels RF1, RF2, RF3, and RF4 through a receiver 610, including four reception modules RX #1, and to include a retransmission signal processor #2 650 supporting both channel bonding technology and multi-antenna transmission technology is illustrated.

The received signals are demodulated by the respective demodulation blocks of the four RF channels, the signals output from respective channel decoding blocks are converted into a single stream through a stream muxing block 620, and the input data converted into the single stream may be converted into a Physical Layer Pipe (PLP) through an input formatting block 630. The PLP is input to a stream partitioning block 640.

The stream partitioning block 640 serves to segment the data to be transmitted to RF channel 1 and RF channel 2. After data is segmented into transmission blocks for the respective RF channels, the transmission blocks are individually input to BICM blocks.

Here, a signaling information block 660 may extract information corresponding to transmission parameters (an FFT size, a guard interval length, a modulation order, a channel code rate, a pilot pattern, and the like) set by a broadcaster, and a retransmission parameter block 670 calculates the total amount of data using the extracted transmission parameters, thereby acquiring the transmission parameters to be applied to a remodulation unit.

Each of the BICM blocks of the retransmission signal processor 650 includes three subblocks, which are a Forward Error Correction (FEC) block, a Bit Interleaver (BIL) block, and a MIMO mapper (MIMO MAP) block. The FEC block generates an FEC frame using a baseband packet. The BIL block performs bit interleaving on the FEC frame generated by the FEC block. The MIMO MAP block includes a demultiplexer block and a bit-to-IQ mapping block. The demultiplexer block serves to segment a bitstream into data cells. Here, the number of data cells that are output may vary depending on a modulation order. The bit-to-IQ mapping block performs constellation mapping on the data cells generated by the demultiplexer block.

Cell exchange blocks may include a first cell exchange block corresponding to transmission antenna 1 (Cell Exchange (Tx 1) block) and a second cell exchange block corresponding to transmission antenna 2 (Cell Exchange (Tx 2) block).

Here, the first cell exchange block (Tx 1) may receive data corresponding to transmission antenna 1 from the output of the MIMO MAP block corresponding to RF channel 1. Also, the first cell exchange block (Tx 1) may receive data corresponding to transmission antenna 1 from the output of the MIMO MAP block corresponding to RF channel 2.

Similarly, the second cell exchange block (Tx 2) may receive data corresponding to transmission antenna 2 from the output of the MIMO MAP block corresponding to RF channel 1. Also, the second cell exchange block (Tx 2) may receive data corresponding to transmission antenna 2 from the output of the MIMO MAP block corresponding to RF channel 2.

Here, the cell exchange blocks may exchange the pieces of received input data. Data exchange may be performed for data cells, the index of which is an odd number, and this indicates a process of sending the data cell for RF channel 1 to RF channel 2 and sending the data cell for RF channel 2 to RF channel 1.

For example, the first cell exchange block (Tx 1) may exchange the data cell of transmission antenna 1 corresponding to RF channel 1 and the data cell of transmission antenna 1 corresponding to RF channel 2 with each other. Also, the second cell exchange block (Tx 2) may exchange the data cell of transmission antenna 2 corresponding to RF channel 1 and the data cell of transmission antenna 2 corresponding to RF channel 2 with each other.

Here, the cell exchange blocks may be enabled or disabled. For example, the first cell exchange block (Tx 1) and the second cell exchange block (Tx 2) may be individually enabled or disabled. Alternatively, the first cell exchange block (Tx 1) and the second cell exchange block (Tx 2) may be enabled or disabled using their own parameters. Alternatively, both the first cell exchange block (Tx 1) and the second cell exchange block (Tx 2) may be enabled or disabled. Alternatively, the first cell exchange block (Tx 1) and the second cell exchange block (Tx 2) may be enabled or disabled using a single parameter.

The data passing through the cell exchange blocks is input to MIMO precoder blocks.

Here, the data cell corresponding to RF channel 1, among the data cells output from the first cell exchange block (Tx 1), and the data cell corresponding to RF channel 1, among the data cells output from the second cell exchange block (Tx 2), are input to the MIMO precoder block corresponding to RF channel 1. The data cell corresponding to RF channel 2, among the data cells output from the first cell exchange block (Tx 1), and the data cell corresponding to RF channel 2, among the data cells output from the second cell exchange block (Tx 2), are input to the MIMO precoder block corresponding to RF channel 2.

Each of the MIMO precoder blocks includes three subblocks, which are a stream combining block, an IQ polarization interleaving block, and a phase hopping block. Here, the subblocks of the MIMO precoder block may be individually enabled or disabled.

For example, when the cell exchange blocks are enabled, the same configuration may be applied to the MIMO precoder blocks for RF channel 1 and RF channel 2. That is, when the cell exchange blocks are enabled, the MIMO precoder block for RF channel 1 and the MIMO precoder block for RF channel 2 may perform the same operation. Alternatively, the MIMO precoder operation may be configured in common for the MIMO precoder blocks for RF channel 1 and RF channel 2. Alternatively, the operation of the MIMO precoder block for RF channel 1 and the operation of the MIMO precoder block for RF channel 2 may be performed in the same manner. Alternatively, the operations of the MIMO precoder blocks for RF channel 1 and RF channel 2 may be performed according to the operation instruction of the MIMO precoder block for RF channel 1. Alternatively, the operations of the MIMO precoder blocks for RF channel 1 and RF channel 2 may be performed according to the operation instruction of the MIMO precoder block for RF channel 2. Here, when the stream combining blocks for RF channel 1 and RF channel 2 are enabled and when the modulation order and the channel code rate for RF channel 1 differ from those for RF channel 2, the operation of the stream combining block for RF channel 1 may be performed differently from the operation of the stream combining block for RF channel 2. Also, when the stream combining blocks for RF channel 1 and RF channel 2 are enabled and when the modulation order and the channel code rate for RF channel 1 are the same as those for RF channel 2, the operation of the stream combining block for RF channel 1 may be performed in the same manner as the operation of the stream combining block for RF channel 2.

In another example, when the cell exchange blocks are disabled, individual configurations may be applied to the MIMO precoder blocks for RF channel 1 and RF channel 2. That is, the operation of the MIMO precoder block for RF channel 1 and the operation of the MIMO precoder block for RF channel 2 may be individually configured. Alternatively, the stream combining block for RF channel 1 and the stream combining block for RF channel 2 may be individually enabled or disabled. Alternatively, the operation of the stream combining block for RF channel 1 may be determined depending on the modulation order and the channel code rate used for RF channel 1, and the operation of the stream combining block for RF channel 2 may be determined depending on the modulation order and the channel code rate used for RF channel 2. Alternatively, the IQ polarization interleaving block for RF channel 1 and the IQ polarization interleaving block for RF channel 2 may be individually enabled or disabled. Alternatively, the phase hopping block for RF channel 1 and the phase hopping block for RF channel 2 may be individually enabled or disabled. The data for transmission antenna 1 and the data for transmission antenna 2 output from the MIMO precoder block may be input to respective framing and interleaving blocks and waveform generation blocks.

The output of framing in the framing and interleaving block may include components such as a preamble and a subframe, and interleaving may include interleaving in time and frequency domains.

The waveform generation block may perform insertion of a pilot, a Multiple-Input Single-Output (MISO) function, Inverse Fast Fourier Transform (IFFT), insertion of a guard interval, insertion of a bootstrap, and the like.

For example, the interleaving operation for transmission antenna 1 and the interleaving operation for transmission antenna 2 in the transmission block corresponding to RF channel 1 may be performed using the same parameter. Similarly, the interleaving operation for transmission antenna 1 and the interleaving operation for transmission antenna 2 in the transmission block corresponding to RF channel 2 may be performed using the same parameter.

In another example, when the cell exchange blocks are enabled, the framing operation for transmission antenna 1 and the framing operation for transmission antenna 2 in the transmission block corresponding to RF channel 1 may be performed using the same parameter. Similarly, when the cell exchange blocks are enabled, the framing operation for transmission antenna 1 and the framing operation for transmission antenna 2 in the transmission block corresponding to RF channel 2 may be performed using the same parameter.

In another example, when the cell exchange blocks are disabled, the framing operation for transmission antenna 1 in the transmission block corresponding to RF channel 1 and the framing operation for transmission antenna 1 in the transmission block corresponding to RF channel 2 may be performed using different parameters. Similarly, when the cell exchange blocks are disabled, the framing operation for transmission antenna 2 in the transmission block corresponding to RF channel 1 and the framing operation for transmission antenna 2 in the transmission block corresponding to RF channel 2 may be performed using different parameters.

The signals passing through the waveform generation blocks may be transmitted through the transmission antennas.

For example, the operation of the waveform generation block for transmission antenna 1 and the operation of the waveform generation block for transmission antenna 2 in the transmission block corresponding to RF channel 1 may be performed using different parameters. That is, the pilot insertion operation for transmission antenna 1 and the pilot insertion operation for transmission antenna 2 in the transmission block corresponding to RF channel 1 may be performed using different parameters. Alternatively, the MISO function operation for transmission antenna 1 and the MISO function operation for transmission antenna 2 in the transmission block corresponding to RF channel 1 may be performed using the same parameter. Alternatively, the IFFT operation for transmission antenna 1 and the IFFT operation for transmission antenna 2 in the transmission block corresponding to RF channel 1 may be performed using the same parameter. Alternatively, the guard interval insertion operation for transmission antenna 1 and the guard interval insertion operation for transmission antenna 2 in the transmission block corresponding to RF channel 1 may be performed using the same parameter. Alternatively, the bootstrap insertion operation for transmission antenna 1 and the bootstrap insertion operation for transmission antenna 2 in the transmission block corresponding to RF channel 1 may be performed using the same parameter.

Accordingly, the framing and interleaving blocks and the waveform generation blocks may be present for transmission antenna 1 and transmission antenna 2, and may be present for RF channel 1 and RF channel 2.

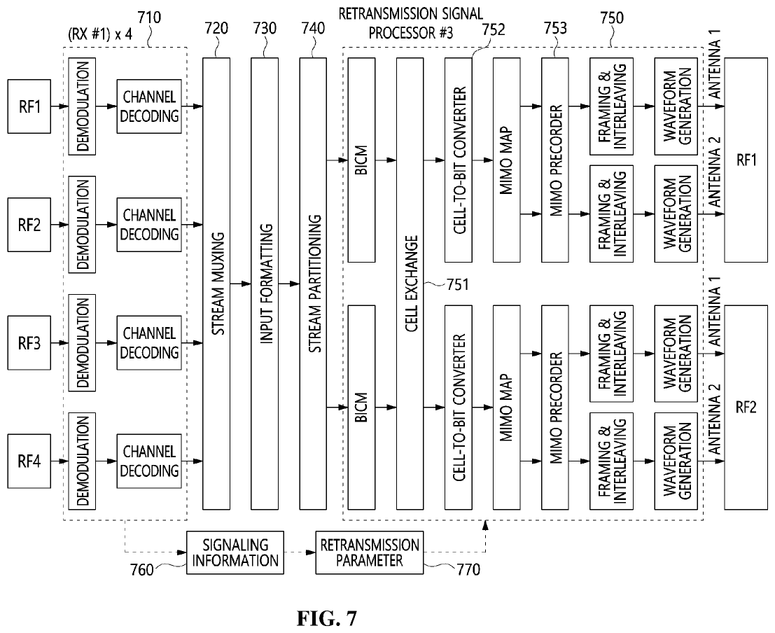

FIG. 7 is a view illustrating a third embodiment of the retransmission-broadcast-signal-processing apparatus that supports both channel bonding transmission technology and multi-antenna transmission technology according to the present disclosure.

Referring to FIG. 7, signals are respectively received from four RF channels RF1, RF2, RF3, and RF4 through a receiver 710 including four receiver modules RX #1, and a retransmission signal processor #3 750 that supports both channel bonding technology and multi-antenna transmission technology is illustrated.

The received signals are demodulated by the respective demodulation blocks of the four RF channels, the signals output from respective channel decoding blocks are converted into a single stream through a stream muxing block 720, and the input data converted into the single stream may be converted into a Physical Layer Pipe (PLP) through an input formatting block 730. The PLP is input to a stream partitioning block 740.

The stream partitioning block 740 serves to segment the data to be transmitted to RF channel 1 and RF channel 2. After data is segmented into transmission blocks for the respective RF channels, the transmission blocks are individually input to BICM blocks.

Here, a signaling information block 760 may extract information corresponding to transmission parameters (an FFT size, a guard interval length, a modulation order, a channel code rate, a pilot pattern, and the like) set by a broadcaster, and a retransmission parameter block 770 calculates the total amount of data using the extracted transmission parameters, thereby acquiring the transmission parameters to be applied to a remodulation unit.

After the data is segmented into transmission blocks for the respective RF channels, the transmission blocks are individually input to the BICM blocks of the retransmission signal processor 750.

Each of the BICM blocks may include three subblocks, which are an FEC block, a BIL block, and a mapper block. The FEC block generates an FEC frame using a baseband packet. The BIL block performs bit interleaving on the FEC frame generated by the FEC block. The mapper block includes a demultiplexer block and a bit-to-IQ mapping block. The demultiplexer block serves to segment a bitstream into data cells. Here, the number of data cells that are output may vary depending on a modulation order. The bit-to-IQ mapping block performs constellation mapping on the data cells generated by the demultiplexer block. The data cells on which constellation mapping is performed may be input to a cell exchange block 751.

The cell exchange block 751 may receive the output of the BICM block corresponding to RF channel 1 and the output of the BICM block corresponding to RF channel 2. The cell exchange block 751 may be enabled or disabled depending on a channel bonding mode.

Here, when the cell exchange block 751 is disabled, the input of the cell exchange block 751 and the output thereof may be the same as each other, whereas when the cell exchange block 751 is enabled, the data of RF channel 1 and the data of RF channel 2 may be exchanged with each other depending on the index of the data cell.

For example, when the index of the data cell is an even number, the data scheduled to be transmitted to RF channel 1 may be formed into a transmission signal and transmitted using the transmission path of RF channel 1. Similarly, the data scheduled to be transmitted to RF channel 2 may be formed into a transmission signal and transmitted using the transmission path of RF channel 2. That is, the input data of the cell exchange block may be the same as the output data thereof.

In another example, when the index of the data cell is an odd number, the data scheduled to be transmitted to RF channel 1 may be formed into a transmission signal and transmitted using the transmission path of RF channel 2. Similarly, the data scheduled to be transmitted to RF channel 2 may be formed into a transmission signal and transmitted using the transmission path of RF channel 1. That is, the RF channel number of the data input to the cell exchange block and the RF channel number of the data output from the cell exchange block may be exchanged.

The outputs of the cell exchange block 751 may be input to respective cell-to-bit converter blocks for RF channel 1 and RF channel 2.

The cell-to-bit converter blocks may be present for RF channel 1 and RF channel 2. The cell-to-bit converter blocks may perform an operation of converting the data, which are converted from bits to data cells through a mapping operation, back into bits. That is, the operation of the cell-to-bit converter blocks may be the same as the inverse operation of constellation mapping of the bit-to-IQ mapping block within the BICM block. The data converted into bits through the cell-to-bit converter blocks is input to MIMO MAP blocks.

Each of the MIMO MAP blocks includes a demultiplexer block and a bit-to-IQ mapping block. The demultiplexer block serves to segment a bitstream into data cells. Here, the number of data cells that are output may vary depending on a modulation order. Also, different modulation orders may be assigned to the transmission block corresponding to RF channel 1 and the transmission block corresponding to RF channel 2. When the different modulation orders are assigned, the number of data cells output from the demultiplexer block within the MIMO mapper block for RF channel 1 may differ from the number of data cells output from the demultiplexer block within the MIMO mapper block for RF channel 2. The bit-to-IQ mapping block performs constellation mapping for the data cell generated through the demultiplexer block.

Here, when the index of the data cell is an even number, the data cell may be mapped to transmission antenna 1, whereas when the index of the data cell is an odd number, the data cell may be mapped to transmission antenna 2.

Each of MIMO precoder blocks includes three subblocks, which are a stream combining block, an IQ polarization interleaving block, and a phase hopping block. The respective subblocks of the MIMO precoder block may be individually enabled or disabled.

For example, when the cell exchange block is enabled, the same configuration may be applied to the MIMO precoder blocks for RF channel 1 and RF channel 2. Alternatively, the MIMO precoder block for RF channel 1 and the MIMO precoder block for RF channel 2 may perform the same operation. Alternatively, the MIMO precoder operation may be configured in common for the MIMO precoder blocks for RF channel 1 and RF channel 2. Alternatively, the operation of the MIMO precoder block for RF channel 1 and the operation of the MIMO precoder block for RF channel 2 may be performed in the same manner. Alternatively, the operations of the MIMO precoder blocks for RF channel 1 and RF channel 2 may be performed according to the operation instruction of the MIMO precoder block for RF channel 1. Alternatively, the operations of the MIMO precoder blocks for RF channel 1 and RF channel 2 may be performed according to the operation instruction of the MIMO precoder block for RF channel 2. Alternatively, when the stream combining blocks for RF channel 1 and RF channel 2 are enabled and when the modulation order and the channel code rate for RF channel 1 differ from those for RF channel 2, the operation of the stream combining block for RF channel 1 may be performed differently from the operation of the stream combining block for RF channel 2. Alternatively, when the stream combining blocks for RF channel 1 and RF channel 2 are enabled and when the modulation order and the channel code rate for RF channel 1 are the same as those for RF channel 2, the operation of the stream combining block for RF channel 1 may be performed in the same manner as the operation of the stream combining block for RF channel 2.

In another example, when the cell exchange block is disabled, individual configurations may be applied to the MIMO precoder blocks for RF channel 1 and RF channel 2. Alternatively, the operation of the MIMO precoder block for RF channel 1 and the operation of the MIMO precoder block for RF channel 2 may be individually configured. Alternatively, the stream combining block for RF channel 1 and the stream combing block for RF channel 2 may be individually enabled or disabled. Alternatively, the operation of the stream combining block for RF channel 1 may be determined depending on the modulation order and the channel code rate used for RF channel 1, and the operation of the stream combining block for RF channel 2 may be determined depending on the modulation order and the channel code rate used for RF channel 2. Alternatively, the IQ polarization interleaving block for RF channel 1 and the IQ polarization interleaving block for RF channel 2 may be individually enabled or disabled. Alternatively, the phase hopping block for RF channel 1 and the phase hopping block for RF channel 2 may be individually enabled or disabled.

The data for transmission antenna 1 and the data for transmission antenna 2 output from the MIMO precoder block may be input to respective framing and interleaving blocks and waveform generation blocks.

The output of framing in the framing and interleaving block may include components such as a preamble and a subframe, and interleaving may include interleaving in time and frequency domains.

The waveform generation block may perform insertion of a pilot, a Multiple-Input Single-Output (MISO) function, Inverse Fast Fourier Transform (IFFT), insertion of a guard interval, insertion of a bootstrap, and the like.

For example, the interleaving operation for transmission antenna 1 and the interleaving operation for transmission antenna 2 in the transmission block corresponding to RF channel 1 may be performed using the same parameter. Similarly, the interleaving operation for transmission antenna 1 and the interleaving operation for transmission antenna 2 in the transmission block corresponding to RF channel 2 may be performed using the same parameter.

In another example, when the cell exchange block is enabled, the framing operation for transmission antenna 1 and the framing operation for transmission antenna 2 in the transmission block corresponding to RF channel 1 may be performed using the same parameter. Similarly, when the cell exchange block is enabled, the framing operation for transmission antenna 1 and the framing operation for transmission antenna 2 in the transmission block corresponding to RF channel 2 may be performed using the same parameter.

In another example, when the cell exchange block is disabled, the framing operation for transmission antenna 1 in the transmission block corresponding to RF channel 1 and the framing operation for transmission antenna 1 in the transmission block corresponding to RF channel 2 may be performed using different parameters. Similarly, when the cell exchange block is disabled, the framing operation for transmission antenna 2 in the transmission block corresponding to RF channel 1 and the framing operation for transmission antenna 2 in the transmission block corresponding to RF channel 2 may be performed using different parameters.

The signals passing through the waveform generation blocks may be transmitted through the transmission antennas.

For example, the operation of the waveform generation block for transmission antenna 1 and the operation of the waveform generation block for transmission antenna 2 in the transmission block corresponding to RF channel 1 may be performed using different parameters. That is, the pilot insertion operation for transmission antenna 1 and the pilot insertion operation for transmission antenna 2 in the transmission block corresponding to RF channel 1 may be performed using different parameters. Alternatively, the MISO function operation for transmission antenna 1 and the MISO function operation for transmission antenna 2 in the transmission block corresponding to RF channel 1 may be performed using the same parameter. Alternatively, the IFFT operation for transmission antenna 1 and the IFFT operation for transmission antenna 2 in the transmission block corresponding to RF channel 1 may be performed using the same parameter. Alternatively, the guard interval insertion operation for transmission antenna 1 and the guard interval insertion operation for transmission antenna 2 in the transmission block corresponding to RF channel 1 may be performed using the same parameter. Alternatively, the bootstrap insertion operation for transmission antenna 1 and the bootstrap insertion operation for transmission antenna 2 in the transmission block corresponding to RF channel 1 may be performed using the same parameter.

Accordingly, the framing and interleaving blocks and the waveform generation blocks may be present for transmission antenna 1 and transmission antenna 2, and may be present for RF channel 1 and RF channel 2.

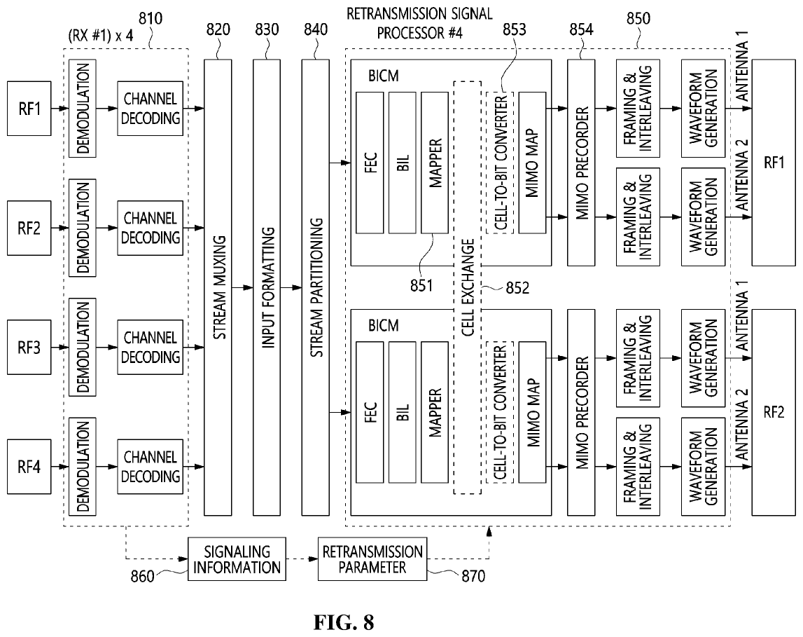

FIG. 8 is a view illustrating a fourth embodiment of the retransmission-broadcast-signal-processing apparatus that supports both channel bonding transmission technology and multi-antenna transmission technology according to the present disclosure.

Referring to FIG. 8, signals are respectively received from four RF channels RF1, RF2, RF3, and RF4 through a receiver 810 including four receiver modules RX #1, and a retransmission signal processor #4 850 that supports both channel bonding technology and multi-antenna transmission technology is illustrated.

The received signals are demodulated by the respective demodulation blocks of the four RF channels, the signals output from respective channel decoding blocks are converted into a single stream through a stream muxing block 820, and the input data converted into the single stream may be converted into a Physical Layer Pipe (PLP) through an input formatting block 830. The PLP is input to a stream partitioning block 840.

The stream partitioning block 840 serves to segment the data to be transmitted to RF channel 1 and RF channel 2. After data is segmented into transmission blocks for the respective RF channels, the transmission blocks are individually input to BICM blocks.

Here, a signaling information block 860 may extract information corresponding to transmission parameters (an FFT size, a guard interval length, a modulation order, a channel code rate, a pilot pattern, and the like) set by a broadcaster, and a retransmission parameter block 870 calculates the total amount of data using the extracted transmission parameters, thereby acquiring the transmission parameters to be applied to a remodulation unit.

After the data is segmented into the transmission blocks for the respective RF channels, the transmission blocks are individually input to the BICM blocks of the retransmission signal processor 850.

Each of the BICM blocks may include five subblocks, which are an FEC block, a BIL block, a mapper block, a cell exchange block 852, and a cell-to-bit converter block.

The FEC block generates an FEC frame using a baseband packet.

The BIL block performs bit interleaving on the FEC frame generated by the FEC block.

The mapper block includes a demultiplexer block and a bit-to-IQ mapping block. The demultiplexer block serves to segment a bitstream into data cells. Here, the number of data cells that are output may vary depending on a modulation order. The bit-to-IQ mapping block performs constellation mapping on the data cells generated by the demultiplexer block. The data cells on which constellation mapping is performed may be input to the cell exchange block.

The cell exchange block 852 may receive the output of the mapper block corresponding to RF channel 1 and the output of the mapper block corresponding to RF channel 2. The cell exchange block may be enabled or disabled depending on a channel bonding mode. When the cell exchange block is disabled, the input of the cell exchange block and the output thereof may be the same as each other, whereas when the cell exchange block is enabled, the data of RF channel 1 and the data of RF channel 2 may be exchanged with each other depending on the index of the data cell.

For example, when the index of the data cell is an even number, the data scheduled to be transmitted to RF channel 1 may be formed into a transmission signal and transmitted using the transmission path of RF channel 1. Similarly, the data scheduled to be transmitted to RF channel 2 may be formed into a transmission signal and transmitted using the transmission path of RF channel 2. That is, the input data of the cell exchange block may be the same as the output data thereof.

In another example, when the index of the data cell is an odd number, the data scheduled to be transmitted to RF channel 1 may be formed into a transmission signal and transmitted using the transmission path of RF channel 2. Similarly, the data scheduled to be transmitted to RF channel 2 may be formed into a transmission signal and transmitted using the transmission path of RF channel 1. That is, the RF channel number of the data input to the cell exchange block and the RF channel number of the data output from the cell exchange block may be exchanged.

The outputs of the cell exchange block may be input to the cell-to-bit converter blocks for RF channel 1 and RF channel 2.

The cell-to-bit converter blocks may be present for RF channel 1 and RF channel 2. The cell-to-bit converter blocks perform an operation of converting the data, which is converted from bits to data cells through a mapping operation, back into bits. That is, the operation of the cell-to-bit converter block may be the same as the inverse operation of constellation mapping of the bit-to-IQ mapping block within the BICM block. The data converted into bits through the cell-to-bit converter blocks is input to MIMO MAP blocks.

Each of the MIMO MAP blocks includes a demultiplexer block and a bit-to-IQ mapping block. The demultiplexer block serves to segment a bitstream into data cells. Here, the number of data cells that are output may vary depending on a modulation order. Also, different modulation orders may be assigned to the transmission block corresponding to RF channel 1 and the transmission block corresponding to RF channel 2. When the different modulation orders are assigned, the number of data cells output from the demultiplexer block within the MIMO mapper block for RF channel 1 may differ from the number of data cells output from the demultiplexer block within the MIMO mapper block for RF channel 2. The bit-to-IQ mapping block performs constellation mapping on the data cell generated through the demultiplexer block.

Here, when the index of the data cell is an even number, the data cell may be mapped to transmission antenna 1, whereas when the index of the data cell is an odd number, the data cell may be mapped to transmission antenna 2.

Each of MIMO precoder blocks includes three subblocks, which are a stream combining block, an IQ polarization interleaving block, and a phase hopping block. The respective subblocks of the MIMO precoder block may be individually enabled or disabled.

For example, when the cell exchange block is enabled, the same configuration may be applied to the MIMO precoder blocks for RF channel 1 and RF channel 2. Alternatively, the MIMO precoder block for RF channel 1 and the MIMO precoder block for RF channel 2 may perform the same operation. Alternatively, the MIMO precoder operation may be configured in common for the MIMO precoder blocks for RF channel 1 and RF channel 2. Alternatively, the operation of the MIMO precoder block for RF channel 1 and the operation of the MIMO precoder block for RF channel 2 may be performed in the same manner. Alternatively, the operations of the MIMO precoder blocks for RF channel 1 and RF channel 2 may be performed according to the operation instruction of the MIMO precoder block for RF channel 1. Alternatively, the operations of the MIMO precoder blocks for RF channel 1 and RF channel 2 may be performed according to the operation instruction of the MIMO precoder block for RF channel 2. Alternatively, when the stream combining blocks for RF channel 1 and RF channel 2 are enabled and when the modulation order and the channel code rate for RF channel 1 differ from those for RF channel 2, the operation of the stream combining block for RF channel 1 may be performed differently from the operation of the stream combining block for RF channel 2. Alternatively, when the stream combining blocks for RF channel 1 and RF channel 2 are enabled and when the modulation order and the channel code rate for RF channel 1 are the same as those for RF channel 2, the operation of the stream combining block for RF channel 1 may be performed in the same manner as the operation of the stream combining block for RF channel 2.

In another example, when the cell exchange block is disabled, individual configurations may be applied to the MIMO precoder blocks for RF channel 1 and RF channel 2. Alternatively, the operation of the MIMO precoder block for RF channel 1 and the operation of the MIMO precoder block for RF channel 2 may be individually configured. Alternatively, the stream combining block for RF channel 1 and the stream combing block for RF channel 2 may be individually enabled or disabled. Alternatively, the operation of the stream combining block for RF channel 1 may be determined depending on the modulation order and the channel code rate used for RF channel 1, and the operation of the stream combining block for RF channel 2 may be determined depending on the modulation order and the channel code rate used for RF channel 2. Alternatively, the IQ polarization interleaving block for RF channel 1 and the IQ polarization interleaving block for RF channel 2 may be individually enabled or disabled. Alternatively, the phase hopping block for RF channel 1 and the phase hopping block for RF channel 2 may be individually enabled or disabled.

The data for transmission antenna 1 and the data for transmission antenna 2 output from the MIMO precoder block may be input to respective framing and interleaving blocks and waveform generation blocks.

The output of framing in the framing and interleaving block may include components such as a preamble and a subframe, and interleaving may include interleaving in time and frequency domains.

The waveform generation block may perform insertion of a pilot, a Multiple-Input Single-Output (MISO) function, Inverse Fast Fourier Transform (IFFT), insertion of a guard interval, insertion of a bootstrap, and the like.

For example, the interleaving operation for transmission antenna 1 and the interleaving operation for transmission antenna 2 in the transmission block corresponding to RF channel 1 may be performed using the same parameter. Similarly, the interleaving operation for transmission antenna 1 and the interleaving operation for transmission antenna 2 in the transmission block corresponding to RF channel 2 may be performed using the same parameter.

In another example, when the cell exchange block is enabled, the framing operation for transmission antenna 1 and the framing operation for transmission antenna 2 in the transmission block corresponding to RF channel 1 may be performed using the same parameter. Similarly, when the cell exchange block is enabled, the framing operation for transmission antenna 1 and the framing operation for transmission antenna 2 in the transmission block corresponding to RF channel 2 may be performed using the same parameter.

In another example, when the cell exchange block is disabled, the framing operation for transmission antenna 1 in the transmission block corresponding to RF channel 1 and the framing operation for transmission antenna 1 in the transmission block corresponding to RF channel 2 may be performed using different parameters. Similarly, when the cell exchange block is disabled, the framing operation for transmission antenna 2 in the transmission block corresponding to RF channel 1 and the framing operation for transmission antenna 2 in the transmission block corresponding to RF channel 2 may be performed using different parameters.

The signals passing through the waveform generation blocks may be transmitted through the transmission antennas.

For example, the operation of the waveform generation block for transmission antenna 1 and the operation of the waveform generation block for transmission antenna 2 in the transmission block corresponding to RF channel 1 may be performed using different parameters. That is, the pilot insertion operation for transmission antenna 1 and the pilot insertion operation for transmission antenna 2 in the transmission block corresponding to RF channel 1 may be performed using different parameters. Alternatively, the MISO function operation for transmission antenna 1 and the MISO function operation for transmission antenna 2 in the transmission block corresponding to RF channel 1 may be performed using the same parameter. Alternatively, the IFFT operation for transmission antenna 1 and the IFFT operation for transmission antenna 2 in the transmission block corresponding to RF channel 1 may be performed using the same parameter. Alternatively, the guard interval insertion operation for transmission antenna 1 and the guard interval insertion operation for transmission antenna 2 in the transmission block corresponding to RF channel 1 may be performed using the same parameter. Alternatively, the bootstrap insertion operation for transmission antenna 1 and the bootstrap insertion operation for transmission antenna 2 in the transmission block corresponding to RF channel 1 may be performed using the same parameter.

Accordingly, the framing and interleaving blocks and the waveform generation blocks may be present for transmission antenna 1 and transmission antenna 2, and may be present for RF channel 1 and RF channel 2.

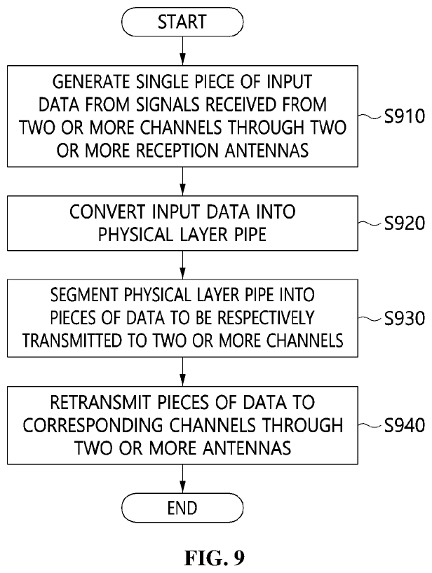

FIG. 9 is a flowchart illustrating a method for processing a retransmission broadcast signal using multi-antenna signals based on channel bonding according to another embodiment of the present disclosure.

Referring to FIG. 9, in the method for processing a retransmission broadcast signal using multi-antenna signals based on channel bonding according to another embodiment of the present disclosure, the stream muxing unit of an apparatus for processing a retransmission broadcast signal using multi-antenna signals based on channel bonding generates a single piece of input data from signals received from two or more reception channels through two or more reception antennas at step S910.

Also, in the method for processing a retransmission broadcast signal using multi-antenna signals based on channel bonding, the input formatting unit of the apparatus for processing a retransmission broadcast signal using multi-antenna signals based on channel bonding converts the input data into a Physical Layer Pipe (PLP) at step S920.

Also, in the method for processing a retransmission broadcast signal using multi-antenna signals based on channel bonding, the stream partitioning unit of the apparatus for processing a retransmission broadcast signal using multi-antenna signals based on channel bonding segments the physical layer pipe into pieces of data to be respectively transmitted to two or more transmission channels at step S930.

Here, the pieces of data may be distributed depending on the amount of data to be transmitted through each of the two or more transmission channels.

Also, in the method for processing a retransmission broadcast signal using multi-antenna signals based on channel bonding, two or more retransmission-signal-processing units of the apparatus for processing a retransmission broadcast signal using multi-antenna signals based on channel bonding retransmit the pieces of data to the respective transmission channels corresponding thereto through multiple transmission antennas at step S940.

Here, the BICM unit of the retransmission-signal-processing unit may segment the pieces of data into the data cells to be respectively transmitted through the multiple transmission antennas, and may then output the data cells.

Here, the FEC unit of the BICM unit may generate an FEC frame using a baseband packet.

Here, the BIL unit of the BICM unit may perform bit interleaving on the FEC frame.

Here, the Multiple-Input Multiple-Output (MIMO) mapping unit of the BICM unit may perform segmentation into the data cells to be respectively transmitted through the multiple antennas.

Here, the demultiplexer of the MIMO mapping unit may segment a bitstream into the data cells.

Here, the bit-to-IQ mapping unit of the MIMO mapping unit may perform constellation mapping on the data cells generated by the demultiplexer.

Here, when the index of the data cell is an even number, the data cell may be mapped to antenna 1, whereas when the index of the data cell is an odd number, the data cell may be mapped to antenna 2.

Here, the Multiple-Input Multiple-Output (MIMO) precoding unit of the retransmission-signal-processing unit may perform streaming combining, IQ polarization interleaving, and phase hopping on each of the data cells and output the data cell.

Here, the cell exchange unit of the retransmission-signal-processing unit may perform data exchange for changing the transmission channel for a data cell, the index of which is an odd number.

Here, the cell-to-bit converter unit of the retransmission-signal-processing unit performs inverse operation of constellation mapping, thereby converting the data cells back into bits.

Also, although not illustrated in FIG. 9, in the method for processing a retransmission broadcast signal using multi-antenna signals based on channel bonding, the signaling information unit of the apparatus for processing a retransmission broadcast signal using multi-antenna signals based on channel bonding extracts information about transmission parameters from the received signals.

Also, although not illustrated in FIG. 9, in the method for processing a retransmission broadcast signal using multi-antenna signals based on channel bonding, the retransmission parameter unit of the apparatus for processing a retransmission broadcast signal using multi-antenna signals based on channel bonding calculates the total amount of data based on the transmission parameters, thereby acquiring the transmission parameters to be applied to the retransmission-signal-processing unit.

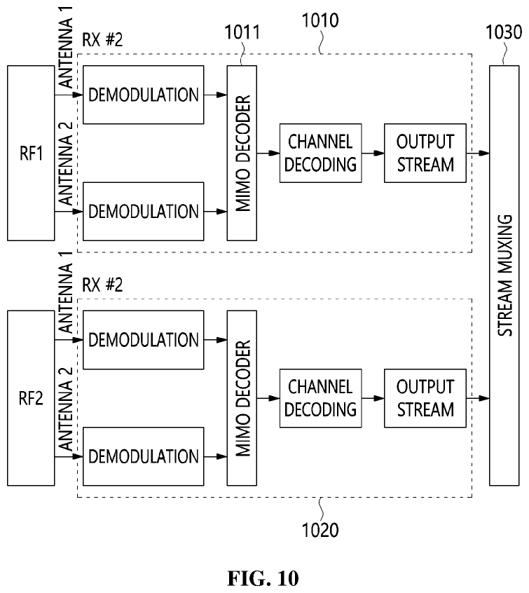

Hereinafter, a signal reception process in a process of processing a retransmission broadcast signal based on various embodiments of a receiver in a retransmission-broadcast-signal-processing apparatus that can be implemented according to the present disclosure will be described in detail with reference to FIGS. 10 to 14.

First, FIG. 10 is a view illustrating a second embodiment of a receiver in a retransmission-broadcast-signal-processing apparatus that supports both channel bonding transmission technology and multi-antenna transmission technology according to the present disclosure.

Referring to FIG. 10, a receiver including two reception blocks 1010 and 1020 each receiving signals of two reception antennas Antenna 1 and Antenna 2 from each of two RF channels RF1 and RF2 by being configured with two receiver modules RX #2 illustrated in FIG. 2 is illustrated.

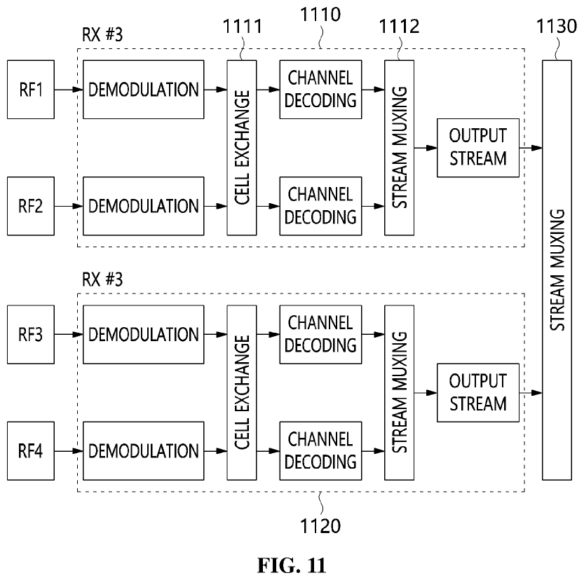

FIG. 11 is a view illustrating a third embodiment of the receiver in the retransmission-broadcast-signal-processing apparatus that supports both channel bonding transmission technology and multi-antenna transmission technology according to the present disclosure.

Referring to FIG. 11, a receiver that includes reception blocks 1110 and 1120 for receiving signals from four RF channels RF1, RF2, RF3, and RF4 by being configured with two receiver modules RX #3 illustrated in FIG. 3 is illustrated.

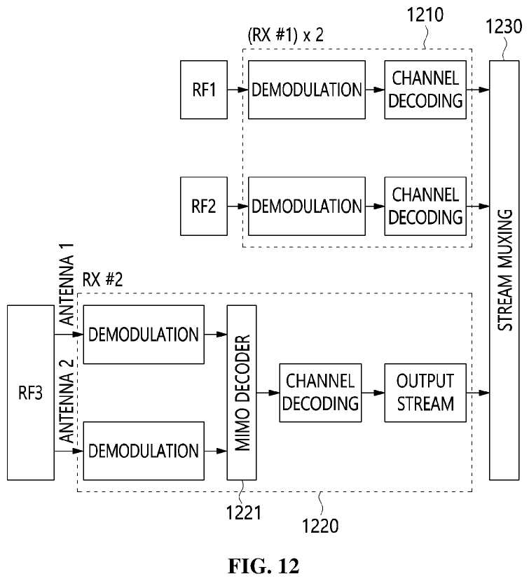

FIG. 12 is a view illustrating a fourth embodiment of the receiver in the retransmission-broadcast-signal-processing apparatus that supports both channel bonding transmission technology and multi-antenna transmission technology according to the present disclosure.

Referring to FIG. 12, a receiver that includes a reception block 1210 for receiving signals from two RF channels RF1 and RF2 by being configured with two receiver modules RX #1 illustrated in FIG. 1 and a reception block 1220 for receiving signals of two reception antennas Antenna 1 and Antenna 2 from one RF channel RF3 by being configured with one receiver module RX #2 illustrated in FIG. 2 is illustrated.

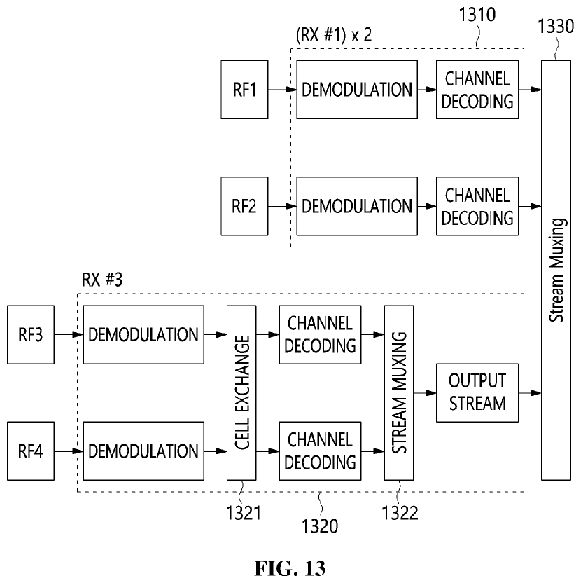

FIG. 13 is a view illustrating a fifth embodiment of the receiver in the retransmission-broadcast-signal-processing apparatus that supports both channel bonding transmission technology and multi-antenna transmission technology according to the present disclosure.

Referring to FIG. 13, a receiver that includes a reception block 1310 for receiving signals from two RF channels RF1 and RF2 by being configured with two receiver modules RX #1 illustrated in FIG. 1 and a reception block 1320 for receiving signals from two RF channels RF3 and RF4 by being configured with one receiver module RX #3 illustrated in FIG. 3 is illustrated.

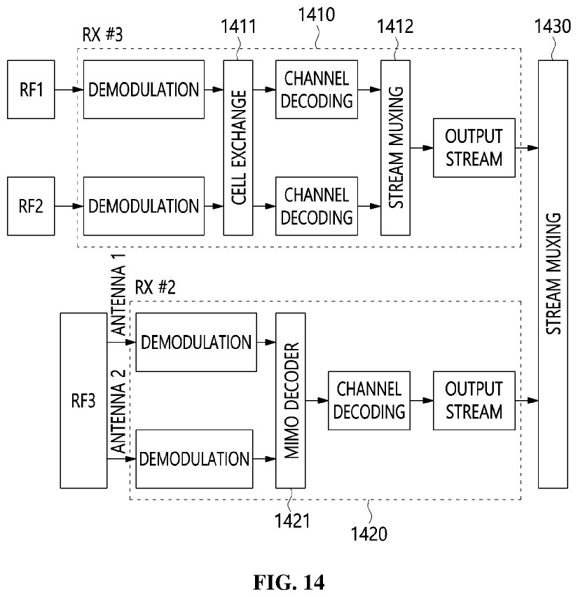

FIG. 14 is a view illustrating a sixth embodiment of the receiver in the retransmission-broadcast-signal-processing apparatus that supports both channel bonding transmission technology and multi-antenna transmission technology according to the present disclosure.

Referring to FIG. 14, a receiver that includes a reception block 1410 for receiving signals from two RF channels RF1 and RF 2 by being configured with one receiver module RX #3 illustrated in FIG. 3 and a reception block 1420 for receiving signals of two reception antennas Antenna 1 and Antenna 2 from one RF channel RF3 by being configured with one receiver module RX #2 illustrated in FIG. 2 is illustrated.

Here, each of the receivers illustrated in FIGS. 10 to 14 is combined with any of the retransmission signal processors #1, #2, #3, and #4 illustrated in FIGS. 5 to 8, thereby being applied to a retransmission-broadcast-signal-processing apparatus according to the present disclosure.

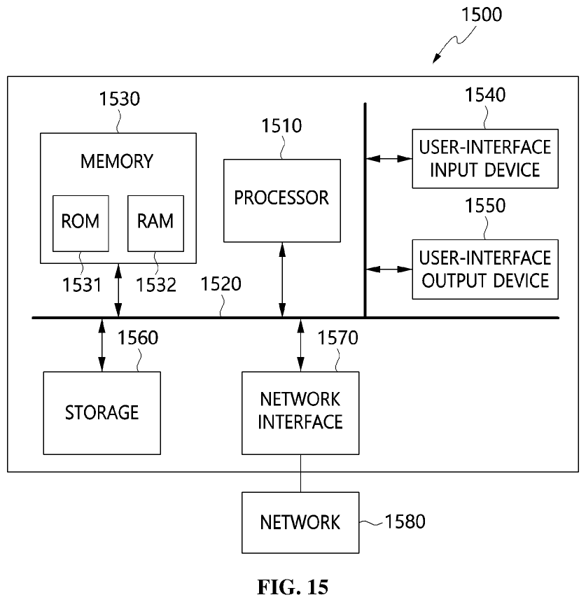

FIG. 15 is a view illustrating a computer system according to an embodiment of the present disclosure.

Referring to FIG. 15, the apparatus for processing a retransmission broadcast signal using multi-antenna signals based on channel bonding according to an embodiment of the present disclosure may be implemented in a computer system including a computer-readable recording medium. As illustrated in FIG. 15, the computer system 1500 may include one or more processors 1510, memory 1530, a user-interface input device 1540, a user-interface output device 1550, and storage 1560, which communicate with each other via a bus 1520. Also, the computer system 1500 may further include a network interface 1570 connected to a network 1580. The processor 1510 may be a central processing unit or a semiconductor device for executing processing instructions stored in the memory 1530 or the storage 1560. The memory 1530 and the storage 1560 may be any of various types of volatile or nonvolatile storage media. For example, the memory may include ROM 1531 or RAM 1532.

Accordingly, an embodiment of the present disclosure may be implemented as a non-transitory computer-readable medium in which methods implemented using a computer or instructions executable in a computer are recorded. When the computer-readable instructions are executed by a processor, the computer-readable instructions may perform a method according to at least one aspect of the present disclosure.

According to the present disclosure, a structure of a retransmission-signal-processing apparatus that supports both channel bonding technology and multi-antenna technology in order to efficiently retransmit broadcast data received from multiple channels, broadcast data received using a channel bonding transmission technology, broadcast data received using a multi-antenna transmission technology, or high-capacity broadcast data received using a combination of these transmission technologies may be provided.

Also, the present disclosure may provide a structure of a retransmission-signal-processing apparatus that can be applied to any of the case in which the broadcast data to be retransmitted is formed based on four RF channels, the case in which the broadcast data to be retransmitted is formed based on two RF channels and two antennas, the case in which the broadcast data to be retransmitted is formed based on two channel combinations using four RF channels, and the case in which the broadcast data to be retransmitted is formed based on combinations of these configurations.

As described above, the method for processing are transmission broadcast signal using multi-antenna signals based on channel bonding and the apparatus for the same according to the present disclosure are not limitedly applied to the configurations and operations of the above-described embodiments, but all or some of the embodiments may be selectively combined and configured, so the embodiments may be modified in various ways.

What is claimed is:

1. An apparatus for processing a retransmission broadcast signal, comprising:
a stream multiplexing (muxing) unit for generating a single piece of input data from signals received from two or more reception channels;
an input formatting unit for converting the input data into a Physical Layer Pipe (PLP);
a stream partitioning unit for segmenting the physical layer pipe into pieces of data to be respectively transmitted over two or more transmission channels; and
two or more retransmission-signal-processing units for retransmitting the pieces of data to the respective transmission channels corresponding thereto through multiple transmission antennas.

2. The apparatus of claim 1, wherein the retransmission-signal-processing unit includes
a Bit-Interleaved Coded Modulation (BICM) unit for segmenting the pieces of data into data cells to be respectively transmitted through the multiple transmission antennas and outputting the data cells;
a Multiple-Input Multiple-Output (MIMO) precoding unit for performing stream combining, IQ polarization interleaving, and phase hopping on each of the data cells and outputting the data cell; and
framing and interleaving units and waveform generation units corresponding to the multiple transmission antennas.

3. The apparatus of claim 2, wherein the retransmission-signal-processing unit further includes a cell exchange unit for performing data exchange for changing the transmission channel for a data cell, an index of which is an odd number.

4. The apparatus of claim 1, further comprising:
a signaling information unit for extracting information about transmission parameters from the received signals; and
a retransmission parameter unit for calculating a total amount of data based on the transmission parameters and acquiring transmission parameters to be applied to the retransmission-signal-processing unit.

5. The apparatus of claim 1, wherein the stream partitioning unit distributes data depending on an amount of data to be transmitted through each of the two or more transmission channels.

6. The apparatus of claim 2, wherein the BICM unit includes
a Forward Error Correction (FEC) unit for generating an FEC frame using a baseband packet;
a Bit Interleaver (BIL) unit for performing bit interleaving on the FEC frame; and
a Multiple-Input Multiple-Output (MIMO) mapping unit for segmentation into the data cells to be respectively transmitted through the multiple transmission antennas.

7. The apparatus of claim 6, wherein the MIMO mapping unit includes
a demultiplexer for segmenting a bitstream into data cells; and
a bit-to-IQ mapping unit for performing constellation mapping on the data cells generated by the demultiplexer.

8. The apparatus of claim 7, wherein the bit-to-IQ mapping unit maps a data cell to antenna 1 when an index of the data cell is an even number, and maps the data cell to antenna 2 when the index of the data cell is an odd number.

9. The apparatus of claim 2, wherein the MIMO precoding unit includes a stream combining unit, an IQ polarization interleaving unit, and a phase hopping unit, and the stream combining unit, the IQ polarization interleaving unit, and the phase hopping unit are individually enabled or disabled.

10. The apparatus of claim 7, wherein the retransmission-signal-processing unit further includes a cell-to-bit converter unit for converting the data cells back into bits by performing an inverse operation of the constellation mapping.

11. An apparatus for processing a retransmission broadcast signal, comprising:
a stream multiplexing (muxing) unit for generating a single piece of input data from signals received from two or more channels through two or more reception antennas;
an input formatting unit for converting the input data into a Physical Layer Pipe (PLP);
a stream partitioning unit for segmenting the physical layer pipe into pieces of data to be respectively transmitted over two or more transmission channels; and
two or more retransmission-signal-processing units for retransmitting the pieces of data to the respective transmission channels corresponding thereto through multiple transmission antennas.

12. A method for processing a retransmission broadcast signal, comprising:
generating, by a stream multiplexing (muxing) unit of an apparatus for processing a retransmission broadcast signal using multi-antenna signals based on channel bonding, a single piece of input data from signals received from two or more reception channels;
converting, by an input formatting unit of the apparatus, the input data into a Physical Layer Pipe (PLP);
segmenting, by a stream partitioning unit of the apparatus, the physical layer pipe into pieces of data to be respectively transmitted over two or more transmission channels; and
retransmitting, by two or more retransmission-signal-processing units of the apparatus, the pieces of data to the respective transmission channels corresponding thereto through multiple transmission antennas.

13. The method of claim 12, wherein retransmitting the pieces of data includes
segmenting, by a Bit-Interleaved Coded Modulation (BICM) unit of the retransmission-signal-processing unit, the pieces of data into data cells to be respectively transmitted through the multiple transmission antennas and outputting, by the BICM unit, the data cells; and
performing, by a Multiple-Input Multiple-Output (MIMO) precoding unit of the retransmission-signal-processing unit, stream combining, IQ polarization interleaving, and phase hopping on each of the data cells and outputting, by the MIMO precoding unit, the data cell.

14. The method of claim 13, wherein retransmitting the pieces of data further includes performing, by a cell exchange unit of the retransmission-signal-processing unit, data exchange for changing the transmission channel for a data cell, an index of which is an odd number.

15. The method of claim 12, further comprising:
extracting, by a signaling information unit of the apparatus, information about transmission parameters from the received signals; and
calculating, by a retransmission parameter unit of the apparatus, a total amount of data based on the transmission parameters and acquiring, by the retransmission parameter unit, transmission parameters to be applied to the retransmission-signal-processing unit.

16. The method of claim 12, wherein segmenting the physical layer pipe comprises distributing data depending on an amount of data to be transmitted through each of the two or more transmission channels.

17. The method of claim 13, wherein segmenting the pieces of data into the data cells and outputting the data cells includes
generating, by a Forward Error Correction (FEC) unit of the BICM unit, an FEC frame using a baseband packet;
performing, by a Bit Interleaver (BIL) unit of the BICM unit, bit interleaving on the FEC frame; and
performing, by a Multiple-Input Multiple-Output (MIMO) mapping unit of the BICM unit, segmentation into the data cells to be respectively transmitted through the multiple transmission antennas.

18. The method of claim 16, wherein performing segmentation into the data cells includes
segmenting, by a demultiplexer of the MIMO mapping unit, a bitstream into data cells; and
performing, by a bit-to-IQ mapping unit of the MIMO mapping unit, constellation mapping on the data cells generated by the demultiplexer.

19. The method of claim 18, wherein performing the constellation mapping comprises mapping a data cell to antenna 1 when an index of the data cell is an even number and mapping the data cell to antenna 2 when the index of the data cell is an odd number.

20. The method of claim 18, further comprising:
converting, by a cell-to-bit converter unit of the retransmission-signal-processing unit, the data cells back into bits by performing an inverse operation of the constellation mapping.
